(19) United States
(12) Patent Application Publication
(10) Pub. No.: US 2016/0263582 A1
(43) Pub. Date: Sep. 15, 2016

(54) MATERIAL REDUCTION MACHINE WITH ADJUSTABLE DISCHARGE AIR FLOW CONTROL

(71) Applicant: Astec Industries, Inc., Chattanooga, TN (US)

(72) Inventor: Bradley Simon Harness, Springfield, OR (US)

(73) Assignee: Astec Industries, Inc., Chattanooga, TN (US)

(21) Appl. No.: 15/059,854

(22) Filed: Mar. 3, 2016

Related U.S. Application Data
(60) Provisional application No. 62/131,040, filed on Mar. 10, 2015.

(51) Int. Cl. B02C 18/22; B02C 18/18; B27L 11/02; B02C 18/14

(52) U.S. Cl. CPC B02C 18/2216; B02C 18/14; B02C 18/18; B27L 11/02

(57) ABSTRACT

A material reduction machine includes a frame and a reducing assembly having a cutting element that is mounted for rotation with respect to the frame. The machine includes a feed chute for directing material to be reduced to the reducing assembly, and housing assembly includes a reducing assembly housing which at least partially encloses the reducing assembly and a discharge chute for directing reduced material away from the reducing assembly. An opening in the housing assembly located downstream of the reducing assembly forms an air inlet though which air may be drawn from outside the housing assembly. An air inlet adjustment assembly is mounted so as to be capable of selectively changing the length of the air inlet.

### CROSS-REFERENCE TO RELATED APPLICATION

This application claims the benefit of U.S. Provisional Patent Application No. 62/131,040, which was filed on Mar. 10, 2015.

### FIELD OF THE INVENTION

The present invention relates generally to material reduction machines such as wood chippers, and more particularly, to a material reduction machine having a rotating reducing assembly having one or more cutting elements spaced about its outer periphery.

### BACKGROUND OF THE INVENTION

Material reduction machines are used to reduce larger pieces of material into smaller pieces by cutting, chopping, shredding or breaking. Generally, a material reduction machine will have an enclosure for a reducing assembly, such as a rotating disc or drum equipped with cutting elements such as blades, knives or hammers. The enclosure will typically have a feed inlet through which the larger materials to be reduced are introduced, and a discharge outlet through which the smaller materials are discharged after reduction. One type of material reduction machine is a wood chipper that is used to reduce trees and their limbs and branches to wood chips. The use of wood chippers avoids the environmental and other problems associated with burning trees and brush or with depositing them in a landfill. Furthermore, by reducing wood to chips of a useful size, a wood chipper may be employed to produce a valuable chip product. Wood chips can be used as mulch or fuel. They can also be used as raw material for creating a pelletized fuel product or as raw material in a chemical pulp process.

Most wood chippers are either disc chippers or drum chippers. Disc chippers include knives mounted on a rotating disc that cut across the grain of the wood stem generally perpendicular to the direction of the grain. Drum chippers include knives mounted around the circumferential wall of a cylindrical drum that cut across the wood feed stock in a path that varies with respect to the orientation of the grain of the feed stock to the drum. The cutting drum of a drum chipper is rotated in a generally cylindrical housing having only a slightly larger diameter than the arc cut by the leading edges of the knives. Because such drum chippers are known to jam with chips and stall, some such chippers are provided with blowers or augers to release the chips from the knives and propel them into a discharge chute.

It is also known to reduce the likelihood of a drum chipper stalling in operation by providing the drum with a pocket associated with each knife. U.S. Pat. No. 5,005,620 describes a drum chipper in which the peripheral wall of the drum defines a spaced pocket behind each knife. Each knife in this assembly is positioned within its pocket so that chips cut by the knife may occupy the pocket as the drum rotates. The wood chips in each pocket remain in the pocket until the drum rotates the pocket past the area in contact with the wood feed stock to the rotational position where the pocket is aligned with the discharge chute, where the chips are expelled into the chute under the influence of centrifugal force.

U.S. Pat. No. 6,036,125 describes a wood chipper having a housing that contains a cutting assembly, an inlet to the housing for the introduction of material to be reduced and an outlet from the housing that has a generally vertical wall portion. A vertically directed discharge chute includes a lower wall portion that overhangs or overlaps the generally vertical wall portion of the outlet of the housing in such a way as to form a space of predetermined fixed size between the lower wall portion of the discharge chute and the generally vertical wall portion of the housing outlet. Two purposes for this space are described in U.S. Pat. No. 6,036,125. The first is to allow larger wood chips which are too heavy to travel up the discharge chute to fall in the space between the vertical wall of the discharge chute and the vertical wall of the housing outlet and out of the wood chipper. The second purpose is to allow air to flow out of the lower end of the discharge chute alongside the generally vertical wall portion of the outlet housing to prevent plugging of the cutting assembly.

It is frequently desirable to provide a drum chipper that is capable of discharging chips some distance beyond the end of the discharge chute. In fact, the throwing distance of a drum chipper may be an important performance consideration. For this reason, some drum chippers are equipped with an accelerator assembly that is adapted to accelerate material out of the discharge chute. U.S. Pat. No. 8,783,593 describes and illustrates a drum chipper having such an accelerator assembly that includes an accelerator wheel having a plurality of blades. This accelerator wheel is rotated in the same direction as the drum to increase the momentum of reduced material out the discharge chute. The machine of U.S. Pat. No. 8,783,593 also includes a gauging component that is located downstream of the drum and includes a plurality of flow diverters that are spaced across the width of the drum so as to provide a plurality of sized openings through which reduced material from the drum may pass. If the machine is provided with both an accelerator wheel and a gauging component, the gauging component is typically located between the drum and the accelerator wheel. The accelerator wheel has been shown to increase the velocity of chips cut by the drum out of the discharge chute, thus increasing the throwing distance of the machine. It is also known that increasing the flow of air into the discharge chute can aid in increasing the throwing distance of the machine. Thus, the machine of U.S. Pat. No. 8,783,593 includes a small air inlet of fixed size adjacent to the gauging component. This air inlet, unlike that of U.S. Pat. No. 6,036,125, allows outside air to be drawn into the discharge chute and accelerated in the discharge direction, thereby increasing the throwing distance of the machine.

It has been found, however, that the throwing distance of a drum chipper machine is affected by the type of wood being processed, by the condition and moisture content of the source wood material, and by the size of the chips being cut. It has also been found that increasing the velocity of inlet air flow into the region downstream of the reducing assembly can lift and entrain slowly moving or stalled chips back into the airstream flowing through the discharge chute. Consequently, the inventor has learned that there are advantages to providing a means for providing an adjustable flow of air from outside the machine into the discharge chute, depending on various factors including the type and moisture content of the wood being processed, in order to increase the throwing distance of the machine for a particular type of material.

It would be desirable therefore, if a material reduction machine such as a drum chipper could be provided with a mechanism that would allow for an adjustable amount of outside air to be introduced into the discharge chute.

### Advantages of the Invention

Among the advantages of a preferred embodiment of the invention is that it provides a wood-chipper that includes a mechanism which can be adjusted to vary the amount of air that is drawn from outside the housing assembly and introduced into the discharge chute in order to maintain an acceptable throwing distance regardless of the type, condition and moisture content of the wood being processed. Other advantages and features of this invention will become apparent from an examination of the drawings and the ensuing description.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic. The use of any and all examples or exemplary language (e.g., “such as”) herein is intended merely to better illuminate the invention and not to place a limitation on the scope of the invention. Nothing in the specification should be construed as indicating any element as essential to the practice of the invention unless so stated with specificity.

Various terms are specifically defined herein. These terms are to be given their broadest possible construction consistent with such definitions, as follows:

The term “material reduction machine” refers to a machine that is adapted to cut, chop, shred, break or otherwise reduce wood or other material into smaller pieces.

The terms “upper”, “top” and similar terms, when used in reference to a relative position or direction on or with respect to a material reduction machine, or a component, portion or feature of such a machine, refer to a relative position or direction that is farther away from the ground on which the material reduction machine is placed for operation.

The terms “lower”, “bottom” and similar terms, when used in reference to a relative position or direction on or with respect to a material reduction machine, or a component, portion or feature of such a machine, refer to a relative position or direction that is nearer the ground on which the material reduction machine is placed for operation.

The term “discharge direction” means the direction that reduced material is conveyed from the discharge chute of the material reduction machine, along the centerline of the discharge chute.

The term “throwing distance” means the distance that reduced material is conveyed from the outlet of the discharge chute.

The term “front end” and similar terms refer to the end of a material reduction machine, or a component, feature or portion of such a machine, which is farthest from the outlet of the discharge chute of the machine.

The terms “forward”, “in front of”, “upstream” and similar terms, as used herein to describe a relative position or direction on or in connection with a material reduction machine or a component, feature or portion of such a machine, refer to a relative position or direction towards the front end of the machine.

The terms “back end”, “rear end” and similar terms refer to the end of a material reduction machine, or a component, feature or portion of such a machine, which is nearest the outlet of the discharge chute of the machine.

The terms “rearward”, “behind”, “downstream” and similar terms, as used herein to describe a relative position or direction on or in connection with a material reduction machine, or a component, feature or portion of such a machine, refer to a relative position or direction towards the rear end of the machine.

The term “width”, as used herein to describe a material reduction machine, or a component, feature or portion of such a machine, refers to a dimension of the machine, component, feature or portion in a direction measured along a line that is perpendicular to the discharge direction and generally parallel to the surface on which the machine is placed for operation.

The term “length”, as used herein to describe a material reduction machine, or a component, feature or portion of such a machine, refers to a dimension of the machine, component, feature or portion in a direction measured along a line that is in, or parallel to, the discharge direction.

### SUMMARY OF THE INVENTION

The invention comprises a material reduction machine that includes a frame and a reducing assembly that is mounted for rotation with respect to the frame. A feed chute is provided for introduction of material to be reduced to the reducing assembly. The machine includes a housing assembly including a plurality of walls. The housing assembly further comprises a reducing assembly housing which at least partially encloses the reducing assembly and a discharge chute for directing reduced material away from the reducing assembly. An opening is provided in the housing assembly downstream of the reducing assembly. This opening comprises an air inlet through which air may be drawn from outside the housing assembly when the reducing assembly is rotated with respect to the frame. A gap plate assembly is adjustably mounted so as to be capable of selectively changing the size of the air inlet.

In some embodiments of the invention, the housing assembly may comprise an intermediate housing that is located adjacent to the reducing assembly housing. In such embodiments, the air inlet may be located downstream of the intermediate housing. In other embodiments of the invention, the housing assembly includes an accelerator wheel housing that is located downstream of the reducing assembly and upstream of the discharge chute. In such embodiments, the air inlet may be located adjacent the accelerator wheel housing.

In order to facilitate an understanding of the invention, the preferred embodiments of the invention are illustrated in the drawings, and a detailed description thereof follows. It is not intended, however, that the invention be limited to the particular embodiments described or to use in connection with the apparatus illustrated herein. Various modifications and alternative embodiments such as would ordinarily occur to one skilled in the art to which the invention relates are also contemplated and included within the scope of the invention described and claimed herein.

### BRIEF DESCRIPTION OF THE DRAWINGS

The presently preferred embodiments of the invention are illustrated in the accompanying drawings, in which:

FIG. 1 is a perspective view of a material reduction machine that may include the invention.

FIG. 2 is a schematic sectional view of a portion of the reducing assembly and adjacent accelerator wheel of a material reduction machine such as is illustrated in FIG. 1, except that the machine is provided with a conventional air inlet of fixed length that is located downstream of the reducing assembly.

FIG. 3 is a perspective view of a gauging component that comprises a part of a preferred embodiment of the invention.

FIG. 4 is a schematic sectional view of a portion of the reducing assembly and adjacent discharge chute for a material reduction machine that does not have an accelerator wheel, but which is provided with a conventional air inlet of fixed length that is located downstream of the reducing assembly.

FIG. 5 is a side view of a portion of a material reduction machine which illustrates the gauging component and an adjustable air inlet of a preferred embodiment of the invention.

FIG. 6 is a partial perspective view of the components shown in FIG. 5. FIG. 7 is a bottom view of the components shown in FIGS. 5 and 6.

### DESCRIPTION OF THE PREFERRED EMBODIMENTS OF THE INVENTION

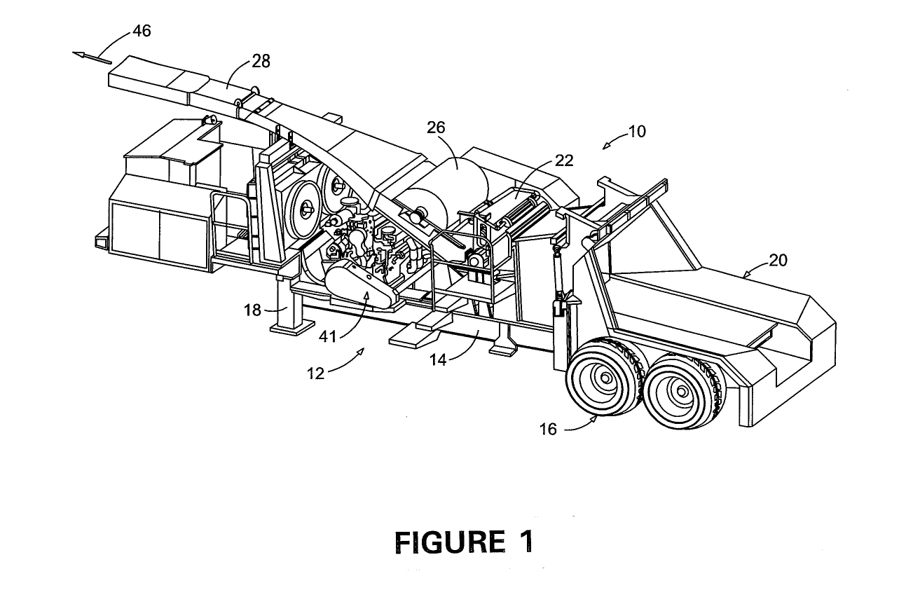

The invention comprises a material reduction machine such as a drum-type wood chipper having a reducing assembly comprising a rotating drum equipped with a plurality of cutting elements. As shown in FIG. 1, wood chipper 10 includes trailer 12 that is adapted to be pulled by a tractor or other vehicle. Trailer 12 includes frame 14 that is supported by wheels 16 and a pair of adjustable support legs, one of which, support leg 18, is shown in FIG. 1. In other embodiments of the invention, the wood chipper can be mounted on a self-propelled frame or chassis.

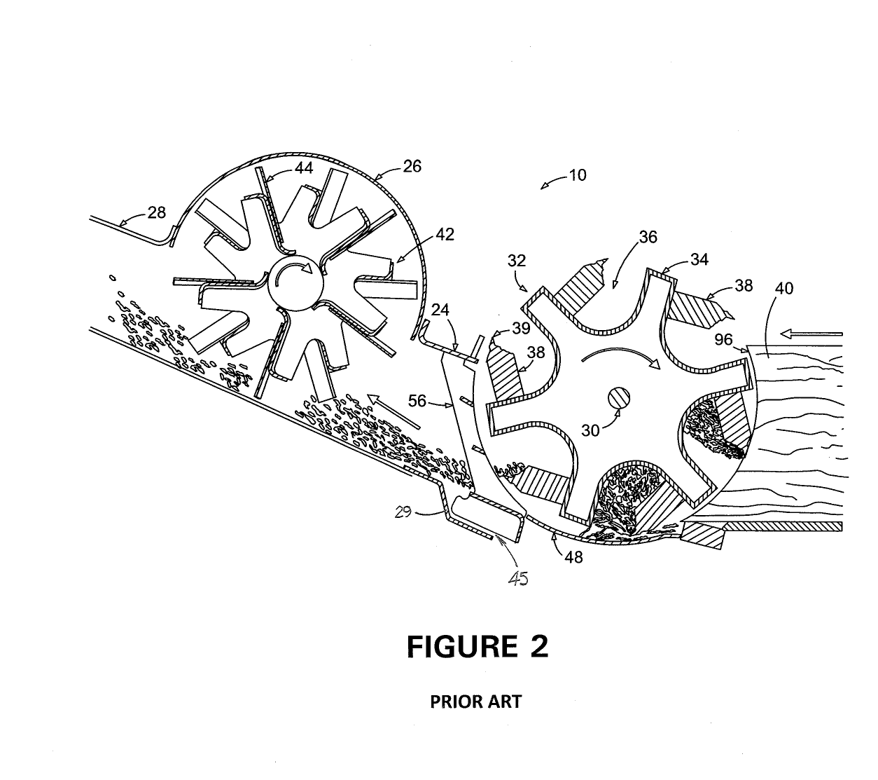

Supported on frame 14 of trailer 12 are feed chute 20, and a housing assembly comprising reducing assembly housing 22, intermediate housing 24 (shown in FIG. 2), accelerator wheel housing 26 and discharge chute 28. Intermediate housing 24 is located downstream of reducing assembly housing 22, and accelerator wheel housing 26 is located downstream of intermediate housing 24. Located within intermediate housing 24 is gauging component 56 (shown in FIG. 2).

Mounted for rotation on shaft 30 (in the clockwise direction, as shown in FIG. 2) is a reducing assembly comprising drum 32 which includes circumferential wall 34 defining its outer periphery. Drum 32 is at least partially enclosed by reducing assembly housing 22. A plurality of pockets 36 are spaced around the drum and formed in the circumferential wall, and a plurality of knives 38, each of which has a leading edge 39 are provided. A knife 38 is mounted on each of the pockets so that as drum 32 rotates, the leading edges 39 of the plurality of knives 38 cut an arc that is concentric with and of a larger diameter than the circumferential wall of the drum, as can be seen by viewing the right side of FIG. 2 where a leading edge of one of the knives is shown cutting into the wood of feed stock 40.

A driver, such as engine 41, is also mounted on the frame and adapted to provide a rotational force to drum 32 within the reducing assembly housing by means of one or more drive belts or other conventional drive transfer mechanisms (not shown). Engine 41 is also adapted to provide a rotational force to accelerator wheel 42, which includes a plurality of blades 44. Preferably, accelerator wheel 42 is rotated in the same direction as drum 32 by means of one or more drive belts or other conventional drive transfer mechanisms (not shown). Fixed air inlet 45 (shown in FIG. 2), which is located downstream of gauging component 56, acts to draw air from outside the housing assembly when drum 32 is rotated with respect to the frame of machine 10. Accelerator wheel 42 and fixed air inlet 45 cooperate to increase the momentum of reduced material from drum 32 into (and out of) discharge chute 28.

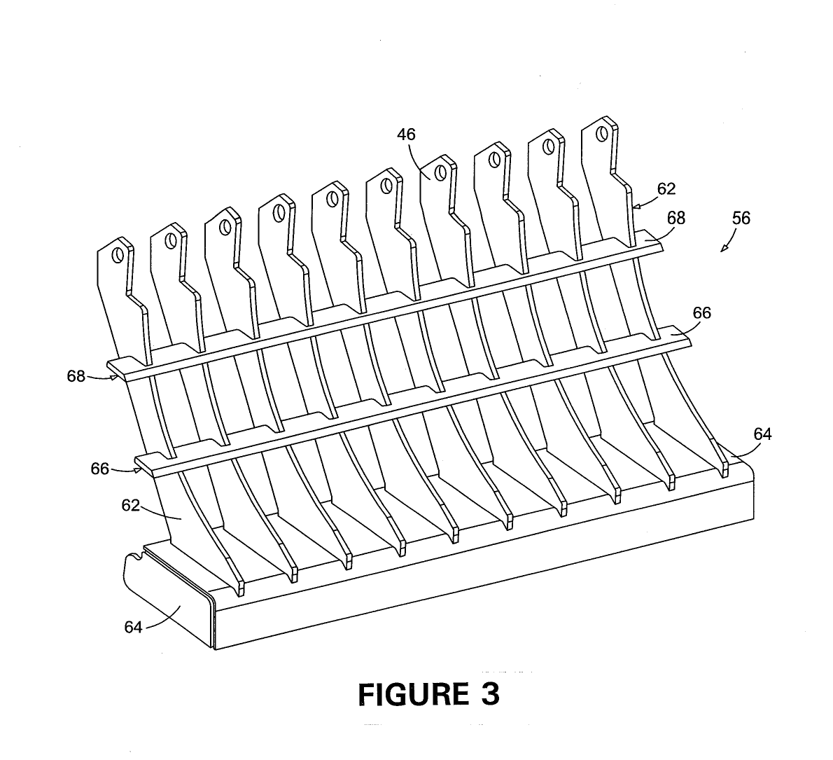

Gauging component 56 (best shown in FIG. 3) is located in intermediate housing 24 that is downstream of and adjacent to reducing assembly housing 22. Gauging component 56 comprises a plurality of generally upright plates 62 that are mounted to base 64 and supported by spacing plates 66 and 68. Generally upright plates 46 are spaced apart across the width of intermediate housing 24 (and across the width of drum 32) between reducing assembly housing 22 and discharge chute 26 so as to provide, in cooperation with spacing plates 66 and 68, a plurality of sized openings through which reduced material such as wood chips cut by the drum may pass. Preferably, each of generally upright plates 62 has a front side that is curved to form an arc. Although FIG. 3 illustrates gauging component 56 as being comprised of plates 62, 66 and 68, it could alternatively be comprised of bars, rods or other shaped components. Furthermore, although FIG. 3 shows the gauging component as including ten generally upright plates and two spacing plates, different numbers of generally upright plates and spacing members may alternatively be provided. The gauging component may impede the progress of long or large chips in the discharge direction, allowing such chips to be carried around the drum housing by the rotation of the drum for further reduction. The gauging component may slightly impede the velocity of properly sized chips into the discharge chute and thereby reduce the throwing distance of the machine, but the improvement in chip consistency offered by the gauging component is considered to outweigh any reduction in throwing distance. The gauging component may also slow the velocity of some properly sized chips to the extent that some of the chips may fall out of the flowing airstream as they pass through the gauging component.

As shown in FIG. 2, air enters intermediate housing 24 through air inlet 45 between guard 29 that is attached to the bottom of chute 28 and gauging component 56. The velocity of this additional air is increased by accelerator wheel 42, along with air that has entered the machine through chute 20, and this high-velocity air flow entrains chips that have been reduced by drum 32. The addition of air through air inlet 45 thus serves to increase the flow rate of air through the machine, thereby increasing the throwing distance of material that is discharged through discharge chute 28 in discharge direction 46.

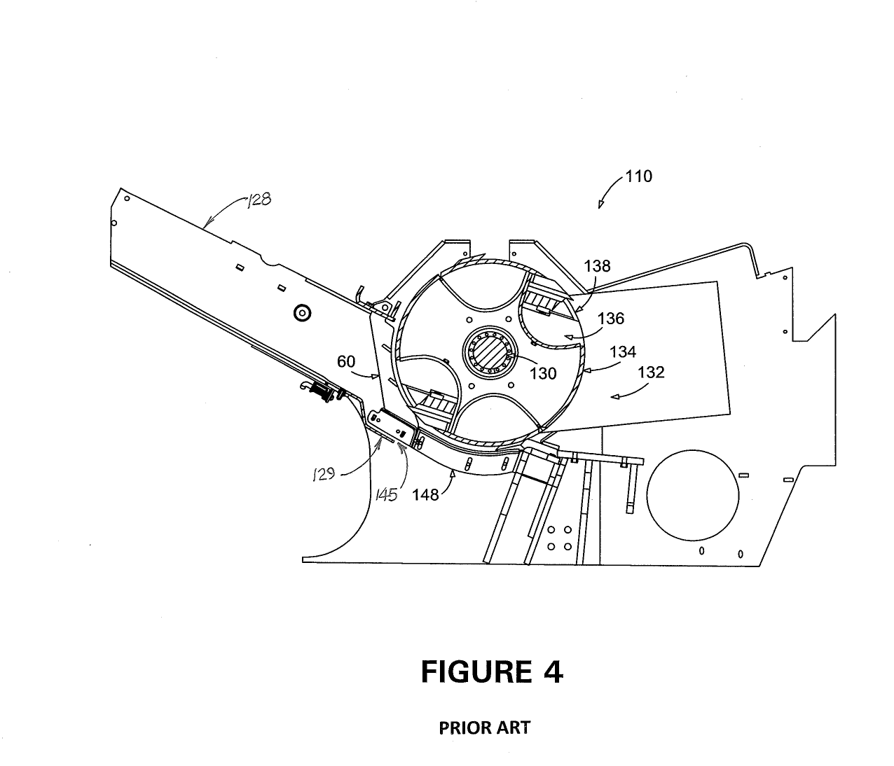

FIG. 4 shows material reduction machine 110, which is similar to material reduction machine 10, but does not include an accelerator wheel. Mounted for rotation about shaft 130 of machine 110 is drum 132, which includes circumferential wall 134 and pockets 136. Knives 138 are mounted on the drum with respect to the circumferential wall so that as the drum rotates, the leading edges of the knives cut an arc that is concentric with and of a larger diameter than the circumferential wall of the drum. Machine 110 also includes belly band assembly 148, which is adjustable with respect to the frame. In addition, machine 110 includes gauging component 60. Air enters the intermediate housing associated with gauging component 60 through air inlet 145 between guard 129 that is attached to the bottom of chute 128 and the gauging component. The addition of air through air inlet 145 serves to increase the flow rate of air through the machine, thereby increasing the throwing distance of material that is discharged through discharge chute 128.

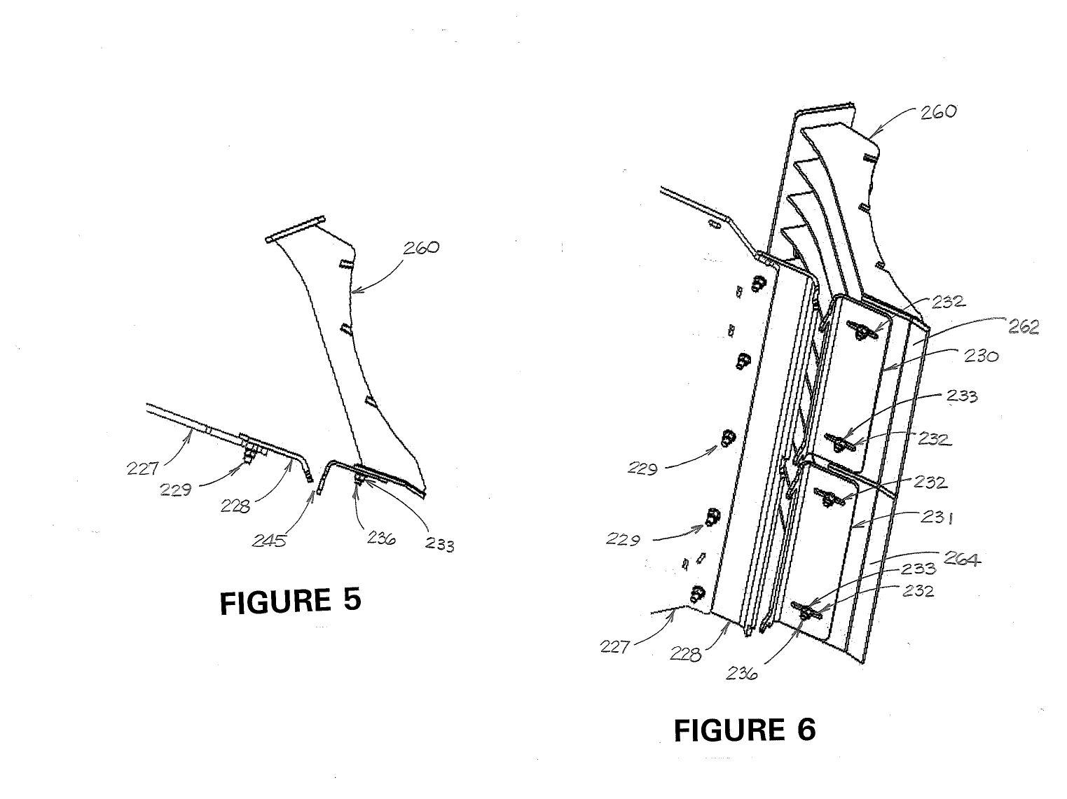

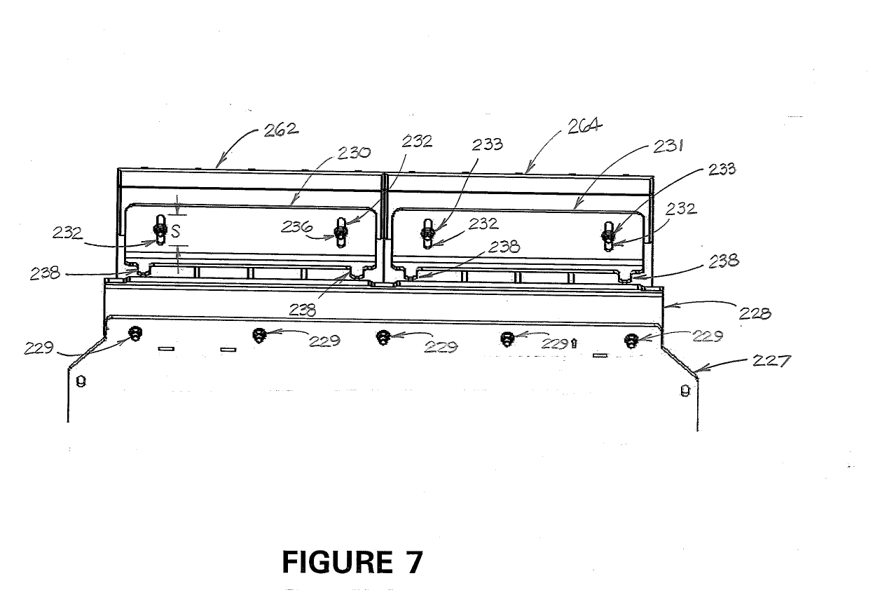

A preferred embodiment of the air inlet adjustment assembly that can be applied to machine 10 or machine 110 is illustrated in FIGS. 5-7. As shown therein, fixed plate 228 is attached to bottom plate 227 of the discharge chute adjacent to the intermediate housing by means of a plurality of fasteners 229. A pair of base plates 262 and 264 form the bottom of gauging component 260. Each of these base plates includes two holes through which a pin in the form of threaded fastener 236 is placed. Positioned below the base plates are a pair of adjustment plates 230 and 231. Each of these adjustment plates includes a pair of slots 232. Each slot 232 has a length “S” and is adapted to receive a pin such as threaded fastener 236 that is attached to a base plate. Each slot 232 cooperates with a pin in the form of threaded fastener 236 to permit the adjustment plates 230 and 231 to be positioned at any of various positions with respect to fixed plate 228, and a nut 233 is applied to each threaded fastener 236 to secure the adjustment plates in the air inlet adjustment assembly in the desired position. This arrangement allows for varying the length of air inlet 245 as desired. Tabs 238 on the rearward ends of adjustment plates 230 and 231 prevent any overlap between the adjustment plates and fixed plate 228. By moving the adjustment plates 230 and 231 toward and away from fixed plate 228, the length of air inlet 245 may be varied to vary the amount of air introduced into the machine downstream of the drum. This permits an operator to “tune” the machine to maximize its throwing distance, depending on the type, condition and moisture content of the material being processed. This also permits an operator to close air inlet 245 completely if it is desired to eliminate the possibility of chips or other material from exiting the discharge chute through the air inlet.

Although this description contains many specifics, these should not be construed as limiting the scope of the invention, but as merely providing illustrations of the presently preferred embodiment thereof, as well as the best mode contemplated by the inventor of carrying out the invention. The invention, as described herein, is susceptible to various modifications and adaptations, as would be understood by those having ordinary skill in the art to which the invention relates, and the same are intended to be comprehended within the meaning and range of equivalents of the appended claims.

What is claimed is:

1. A material reduction machine comprising:
(a) a frame;
(b) a reducing assembly:
(i) that is mounted for rotation with respect to the frame;
(ii) comprising a cutting element for reducing material;
(c) means for rotating the reducing assembly with respect to the frame;
(d) a feed chute for introduction of material to be reduced to the reducing assembly;
(e) a housing assembly comprising:
(i) a reducing assembly housing which at least partially encloses the reducing assembly;
(ii) a discharge chute for directing reduced material away from the reducing assembly;
(iii) an opening in the housing assembly located downstream of the reducing assembly and comprising an air inlet through which air may be drawn from outside the housing assembly when the reducing assembly is rotated with respect to the frame;
(f) an air inlet adjustment assembly that is mounted so as to be capable of selectively changing the size of the air inlet.

2. The material reduction machine of claim 1 wherein the air inlet adjustment assembly is mounted so as to be capable of selectively changing the length of the air inlet.

3. The material reduction machine of claim 1 wherein the reducing assembly comprises a drum that is mounted for rotation within the reducing assembly housing, said drum comprising:
(a) a circumferential wall;
(b) a plurality of pockets spaced around and formed in the circumferential wall;
(c) a plurality of knives, each of which has a leading edge and each of which is mounted on one of the pockets so that as the drum rotates, the leading edges of the plurality of knives cut an arc that is concentric with and of a larger diameter than the circumferential wall of the drum.

4. The material reduction machine of claim 1 wherein:
(a) the housing assembly comprises a first lower wall portion which:
(i) is located downstream of the reducing assembly and upstream of the discharge chute;
(ii) includes a downstream end;
(b) the discharge chute of the housing assembly has a second lower wall portion with an upstream end that is spaced from the downstream end of the first lower wall portion so as to form the air inlet through which air may be drawn from outside the housing assembly when the reducing assembly is rotated with respect to the frame.

5. The material reduction machine of claim 4 wherein the air inlet adjustment assembly comprises:
(a) a fixed plate that is attached to one of the downstream end of the first lower wall portion or the upstream end of the second lower wall portion;
(b) an adjustment plate that is adjustably attached to the one of the downstream end of the first lower wall portion or the upstream end of the second lower wall portion to which the fixed plate is not attached in such a manner as to be moveable with respect to the fixed plate so as to selectively change the size of the air inlet.

6. The material reduction machine of claim 5:
(a) which includes a base plate to which a pair of pins are attached;
(b) wherein the adjustment plate has a pair of slots that:
(i) have a slot length;
(ii) are aligned with and adapted to receive the pins of the base plate so that the adjustment plate is moveable with respect to the base plate by a distance equal to the slot length.

7. The material reduction machine of claim 6 wherein the adjustment plate includes a tab on its rear end that prevents any overlap between the adjustment plate and the base plate.

8. The material reduction machine of claim 1 wherein:
(a) the housing assembly includes an intermediate housing that is located downstream of the reducing assembly housing, said intermediate housing having an intermediate lower wall portion which includes a downstream end;
(b) a gauging assembly is mounted in the intermediate housing and comprises a plurality of flow diverters that are spaced across the width of the intermediate housing so as to provide a plurality of sized openings through which reduced material from the reducing assembly may pass;
(c) the upstream end of the lower wall portion of the discharge chute is spaced from the downstream end of the intermediate lower wall portion of the intermediate housing so as to form the air inlet through which air may enter the discharge chute.

9. The material reduction machine of claim 1:
(a) wherein the housing assembly includes an accelerator wheel housing that is located downstream of the reducing assembly and upstream of the discharge chute;
(b) wherein an accelerator wheel is mounted for rotation in the accelerator wheel housing;
(c) which includes means for rotating the accelerator wheel in the accelerator wheel housing;
(d) wherein the air inlet through which air may be drawn from outside the housing assembly is located adjacent the accelerator wheel housing.

10. The material reduction machine of claim 9 wherein the accelerator wheel is mounted for rotation in the same direction as the reducing assembly and is adapted to increase the momentum of the reduced material from the reducing assembly.

11. A material reduction machine comprising a wood chipper which includes:
(a) a frame;
(b) a reducing assembly:
(i) that is mounted for rotation with respect to the frame;
(ii) comprising a drum having a circumferential wall, a plurality of pockets spaced around and formed in the circumferential wall and a plurality of knives, each of which has a leading edge and each of which is mounted on one of the pockets so that as the drum rotates, the leading edges of the plurality of knives cut an arc that is concentric with and of a larger diameter than the circumferential wall of the drum;
(c) means for rotating the reducing assembly with respect to the frame;
(d) a feed chute for introduction of material to be reduced to the reducing assembly;
(e) a housing assembly comprising:
(i) a reducing assembly housing which at least partially encloses the reducing assembly;
(ii) a discharge chute for directing reduced material away from the reducing assembly;
(iii) an opening in the housing assembly located downstream of the reducing assembly and comprising an air inlet through which air may be drawn from outside the housing assembly when the reducing assembly is rotated with respect to the frame;
(f) an air inlet adjustment assembly that is mounted so as to be capable of selectively changing the size of the air inlet.

12. The material reduction machine of claim 11 wherein:
(a) the housing assembly comprises a first lower wall portion which:
(i) is located downstream of the reducing assembly and upstream of the discharge chute;
(ii) includes a downstream end;
(b) the discharge chute of the housing assembly has a second lower wall portion with an upstream end that is spaced from the downstream end of the first lower wall portion so as to form the air inlet through which air may be drawn from outside the housing assembly when the reducing assembly is rotated with respect to the frame.

13. The material reduction machine of claim 12 wherein the air inlet adjustment assembly comprises:
(a) a fixed plate that is attached to one of the downstream end of the first lower wall portion or the upstream end of the second lower wall portion;
(b) a pair of adjustment plates, each of which is adjustably attached to the one of the downstream end of the first lower wall portion or the upstream end of the second lower wall portion to which the fixed plate is not attached in such a manner as to be moveable with respect to the fixed plate so as to selectively change the size of the air inlet.

14. The material reduction machine of claim 14:
(a) which includes a base plate to which two pairs of pins are attached;
(b) wherein each adjustment plate has a pair of slots, each of which:
(i) has a slot length;
(ii) is aligned with and adapted to receive one of the pins of the base plate so that the adjustment plate is moveable with respect to the base plate by a distance equal to the slot length.

15. The material reduction machine of claim 14 wherein each adjustment plate includes a tab on its rear end that prevents any overlap between the adjustment plate and the base plate.
